(19) United States
(12) Patent Application Publication
(10) Pub. No.: US 2025/0117863 A1
(43) Pub. Date: Apr. 10, 2025

(54) GENERATION OF VERBOSE TAX CATEGORY DESCRIPTIONS USING A GENERATIVE LANGUAGE MODEL

(71) Applicant: Vertex, Inc., King of Prussia, PA (US)

(72) Inventors: Chris Zangrilli, Collegeville, PA (US); Omer Dekel, Bala Cynwyd, PA (US)

(21) Appl. No.: 18/482,666

(22) Filed: Oct. 6, 2023

(51) Int. Cl. G06Q 40/12; G06F 16/33; G06F 16/338; G06F 40/40

(52) U.S. Cl. CPC G06Q 40/123; G06F 16/3347; G06F 16/338; G06F 40/40

(57) ABSTRACT

A computing system for generating verbose tax category descriptions includes a computing device with processing circuitry configured to identify defined tax categories. For each defined tax category, the processing circuitry is configured to extract source text data associated with the defined tax category, generate embeddings representing the source text data, and store the source text embeddings in a vector database. The processing circuitry is further configured to receive an instruction requesting a verbose tax category description of an indicated tax category, generate instruction text embeddings, and query the vector database with the instruction text embeddings to identify a subset of matching source text embeddings. The processing circuitry is further configured to retrieve matching source text data, generate a prompt for a generative language model, input the prompt into the model to generate verbose tax category description text, and output the verbose tax category description text.

### BACKGROUND

Verbose tax category descriptions are textual descriptions of imposed tax categories, which include additional contextual information and examples beyond what is typically included in a tax code. It can be difficult for a user to accurately understand tax category descriptions found in primary legal sources such as tax codes to correctly categorize a product or service to the appropriate tax category. These verbose tax category descriptions, with their additional contextual information and examples, are consulted by users when researching to find the proper tax category for a product or service. Conventionally, generating verbose tax category descriptions is a manual and time-consuming process, as it requires a subject matter expert to manually identify the relevant examples of products and services, understand legal definitions, and then generate a textual description that is both accurate and informative. This process can be especially challenging for large and/or complex tax categories. Further, the overall number of tax categories and associated products and services to be classified at the municipal, county, state, and national levels across the globe, makes verbose tax category description generation a significant burden for companies offering information and advice on tax laws on a national or global scope.

### SUMMARY

To address these issues, a computer system for generating verbose tax category descriptions is provided. According to one aspect, the computing system includes a computing device including processing circuitry configured to execute instructions using portions of associated memory to identify a plurality of defined tax categories. For each defined tax category, the processing circuitry is further configured to extract source text data associated with the defined tax category, generate respective source text embeddings representing the source text data, and store the respective source text embeddings in a vector database. The processing circuitry is further configured to receive an instruction for requesting a verbose tax category description, the instruction including instruction text indicating a tax category, generate instruction text embeddings for the instruction text, and query the vector database with the instruction text embeddings to identify a subset of matching embeddings from among the respective source text embeddings stored in the vector database. The processing circuitry is further configured to retrieve matching source text data associated with the matching embeddings, and generate a prompt for a generative language model based on the matching source text data and the instruction. The processing circuitry is further configured to input the prompt to the generative language model to thereby generate verbose tax category description text for the verbose tax category description, and output the verbose tax category description text.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system for generating verbose tax category descriptions, according to an example implementation.

FIGS. 2A, 2B, and 2C are schematic views of databases storing source text data for the computing system of FIG. 1.

FIG. 3 is an example user interaction history stored by the computing system of FIG. 1.

FIG. 4 is an example prompt generated by the computing system of FIG. 1.

FIG. 5 shows a flowchart for a method for generating verbose tax category descriptions.

FIG. 6 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods or to perform activities. Each of these products fall under a defined tax category. It will be appreciated that the term “product” as used herein may refer to goods, such as tangible products and digital products, as well as services. However, the taxes for a tax category may vary according to jurisdiction, attributes of the product, type of sale, and the like. Verbose tax category descriptions may help a business or organization assign the correct tax category to a product, but the process for generating verbose tax category descriptions is tedious, as a subject matter expert is required classify each product with its correct tax category and create the verbose tax category description. As such, there exists a need for the accurate and expeditious generation of tax category definitions.

To address the issues described above, a computing system 10 for generating verbose tax category descriptions by leveraging a generative language model (GLM) is provided. GLMs are artificial intelligence algorithms that use deep learning techniques and large data sets to generate natural language responses in response to prompts entered by users. Examples of such GLMs include generative pre-trained transformers (GPTs) such as GPT-3, GPT-4, GPT-J, LLaMa, and BLOOM. Typically, these GLMs are sequence transduction transformer models that are trained to make next word predictions to generate an output sequence for a given input sequence. Such models are trained on natural language corpora, including billions of words, and have parameter sizes in excess of one billion parameters. GLMs with large model sizes such as these, are referred to as large language models (LLMs). As a result of their large parameter size and, in some cases, their fine tuning, these GLMs have achieved superior results in generative tasks, such as generating responses to user input in a series of chat-style messages that substantively respond to an instruction in a prompt in accordance with a context of the prompt. Certain generative language models have also been trained to receive multi-modal input, such as text and image input, and to output multi-modal output including generated text and generated images.

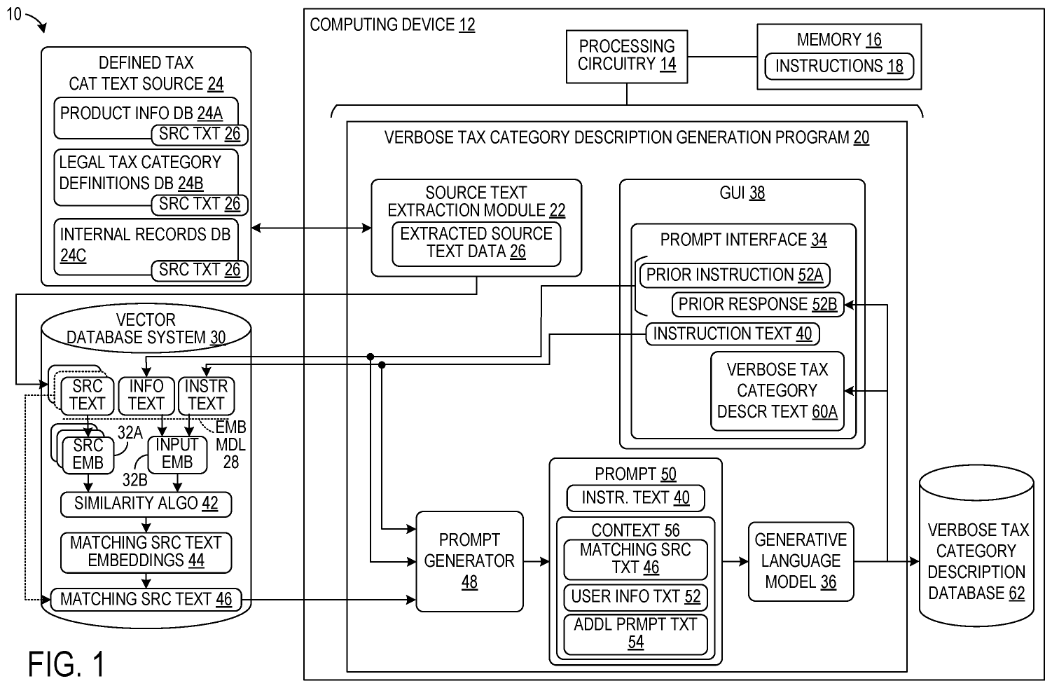

Turning to the Figures, as illustrated in FIG. 1, the computing system 10 includes a computing device 12 with processing circuitry 14 and associated memory 16. The memory 16 stores instructions 18 that cause the processing circuitry 14 to execute a verbose tax category description generation program 20. It will be appreciated that distributed processing strategies may be implemented to execute the verbose tax category description generation program 20 described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. It will additionally be appreciated that the computing device 12 may be implemented as a client device, or as a server device in communication with a client device.

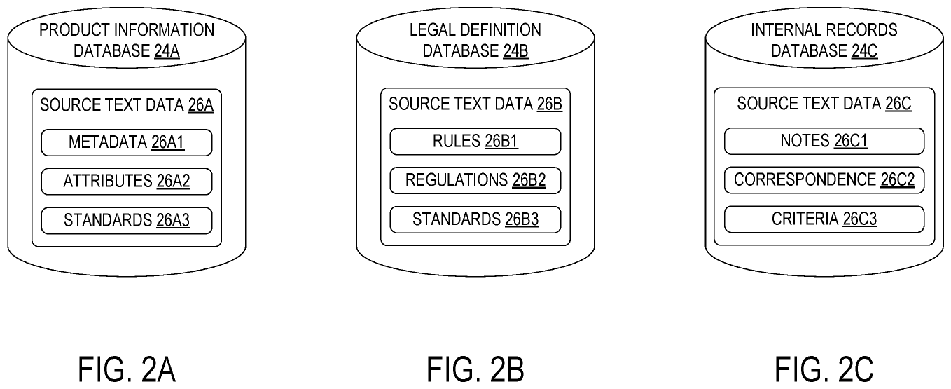

Upon executing the tax category generation program 20, the processing circuitry is configured to implement a source text extraction module 22 to identify a plurality of defined tax categories using a defined tax category text source 24. Information related to the defined tax categories may be stored as source text 26, and the defined tax category text source 24 may be a database, such as a product information database 24A, legal tax category definitions database 24B, an internal research 24C database, and the like, for example, as described in detail below with reference to FIGS. 2A, 2B, and 2C. For each defined tax category, the source text extraction module 22 is configured to extract source text data 26 associated with the defined tax category.

A vector database system 30 is provided that includes an embeddings generation model 28 configured to convert items of text to embeddings, as well as a vector database configured to hold vectors of the embeddings for each of the items of text. The vector database system 30 may further include a database to hold the text data itself, as well as a similarity algorithm 42 for comparing the similarity of different embedding vectors.

Respective source text embeddings 32A representing the extracted source text data 26 are generated by the embeddings model 28, and stored in the vector database of the vector database system 30. The items of extracted source text 26 may also be stored in a database of the vector database system 30, and linked to the source text embeddings 32A generated for each item of extracted source text. In addition, the source text embeddings 32A may be indexed within the vector database system 30 according to a defined tax category, a product, a jurisdiction, and the like, for example, by one or more indexing algorithms.

The processing circuitry 14 may be configured to cause a prompt interface 34 for a generative language model (GLM) 36 to be presented. While the example prompt interface 34 illustrated in FIG. 1 is presented in a graphical user interface (GUI) 38 that is configured to accept user input and present information to a user, it will be appreciated that the prompt interface 34 may be presented as an audio interface for receiving and/or outputting audio such that it may be used with a digital assistant, or implemented as a prompt interface application programming interface (API). Additionally, it will be appreciated that the GLM 36 may be included in the computing system 10 described herein, or it may be implemented as an open source GLM that is hosted at a location separate from the computing system 10.

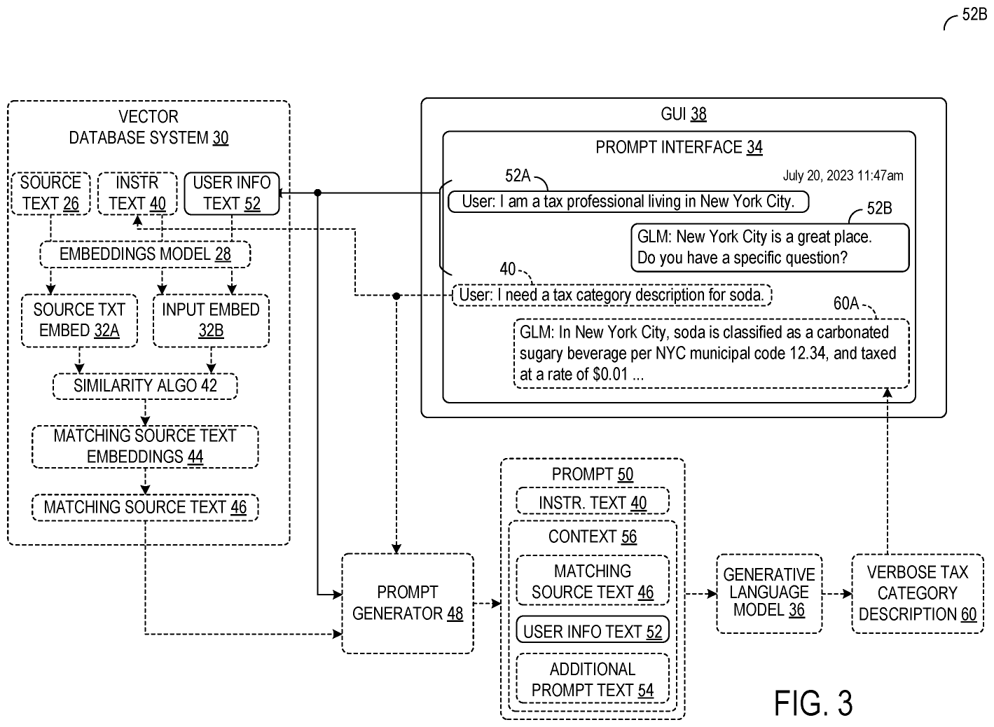

A user may input into the prompt interface 34 an instruction requesting a verbose tax category description. Alternatively, a program (such as script) may be executed that programmatically generates the instruction. The instruction includes instruction text 40 indicating a tax category for which the verbose tax category description is requested, such as a tax category name, a tax category type, a product, and/or a jurisdiction, for example. The prompt interface may be used to request a verbose tax category description of just one tax category, or may be used iteratively to generate descriptions for a subset of tax categories or all tax categories for a jurisdiction, for example. For each request, the embeddings model 28, indicated by the dashed line in FIG. 1, generates instruction text embeddings for the instruction text 40, as well as embeddings representing any user information text 52, such as a user interaction history, user location, user occupation, company type, business domain, and other information that provides context about the user to influence the output tax category description. As discussed in detail below with reference to the example shown in FIG. 3, the user information text 52 may include text entered and received via the prompt interface 34, such as prior instruction 52A and prior response 52B exchanges. In this way, a user requesting the system to generate a verbose tax category description can revise or fine tune the description through the use of multiple prompts in an interaction session, with later prompts building on or revising the output generated in response to earlier prompts.

Together, the embeddings representing the instruction text 40 and the embeddings representing the user information text 52 comprise input embeddings 32B. The vector database system 30 is queried with the input embeddings 32B, which causes a similarity algorithm 42 to be executed. The similarity algorithm 42 scans the vector database system 30 to identify a subset of matching source text embeddings 44 from among the respective source text embeddings 32A that represent source text data 26 for each defined tax category. A variety of measures may be used by the similarity algorithm to identify which of the various source text embeddings 32A most closely match the input embeddings 32B, such as Euclidean distance, cosine, or dot product distance between the embedding vectors for each. The matching source text data 46 associated with the matching source text embeddings 44 is retrieved and sent to the prompt generator 48. In response, the prompt generator 48 generates a prompt 50 for the GLM based on at least the matching source text data 46 and the instruction text 40.

Additionally, as shown in FIG. 1, the prompt generator 48 may receive the user information text 52 and additional prompt text 54 identified via the input embeddings representing the instruction text 40 and user information text 52. The matching source text data 46, user information text 52, and the additional prompt text 54 provide context 56 for the instruction text 40 in the prompt 50. It will be appreciated that the prompt generator 48 may be configured to supply the instruction text 40, the matching source text data 46, the user information text 52, and/or the additional prompt text 54 in a filtered or modified form.

The prompt 50 is input to the to the GLM 36, which is configured to output a verbose tax category description 60. The verbose tax category description 60 is output and displayed as verbose tax category description text 60A in the prompt interface 34 of the GUI 38. Additionally, the verbose tax category description 60 may be stored in a verbose tax category description database 62. Should the user iterate through a series of versions of the verbose tax category description, the user can choose which version to save in the database 62.

FIGS. 2A, 2B, and 2C provide schematic views of databases that store text data 26 associated with tax categories for the verbose tax category description generation program 20. As discussed above and shown in FIG. 1, text data 26 for each defined tax category 24 may be stored in the product information database 24A, the legal category definitions database 24B, and/or the internal research database 24C.

The product information database 24A may include text data 26A for metadata 26A1, attributes 26A2, and standards 26A3 associated with products mapped to the defined tax category 24, such as a product description, a physical attribute, a product tree location, nutritional information, a standard product code, and the like.

The legal definition database 24B may include text data 26B for jurisdictional rules 26B1, jurisdictional regulations 26B2, industry bodies, and industry standards 26B3 that are applied in defining the defined tax category. At least one governing body for each defined tax category 24 is identified. As the legal definitions of defined tax categories are subject to change, the verbose tax category description generation program 20 may be configured to periodically monitor the governing bodies for updates, update the tax category embeddings 32 that represent the text data 26 associated with the defined tax category 24 in the vector database system 30, and revise product mapping according to the updated text data 26.

The internal research database 24C may include text data 26C of notes 26C1 relevant to the defined tax category 24, customer/client correspondence 26C2 related to the defined tax category 24, and decision criteria 26C3 for assigning the defined tax category 24 to one or more products.

An important feature of GLMs is the capacity to generate responses to user input in a series of chat-style messages. As discussed above, the user interaction history between a user and the GLM 36 can provide user information 52 for the context 56 for subsequent interactions and prompts 50 from the user. A user interaction history is shown in FIG. 3 as an example of user information text 52. It will be appreciated that the user interaction history text, including an instruction 52A and a response 52B, is shown in solid line to indicate a historical interaction, and elements for generating a verbose tax category description 60 are shown in dashed line to indicate future events.

In the prior instruction 52A, the user indicated that the user is a tax professional living in New York City. The GLM 28 “chats” with the user in the prior response 52B to determine if there is a specific question. The user interaction history text 52A, 52B is transmitted to the embedding model 28 as user information text 52. The embedding model 28 generates embeddings representing the user information text 52, which are stored in the vector database system 30 as input embeddings 32B, along with embeddings representing the instruction text 40. The user information text 52 is additionally transmitted to the prompt generator 48 where it will be processed and included in a subsequent prompt.

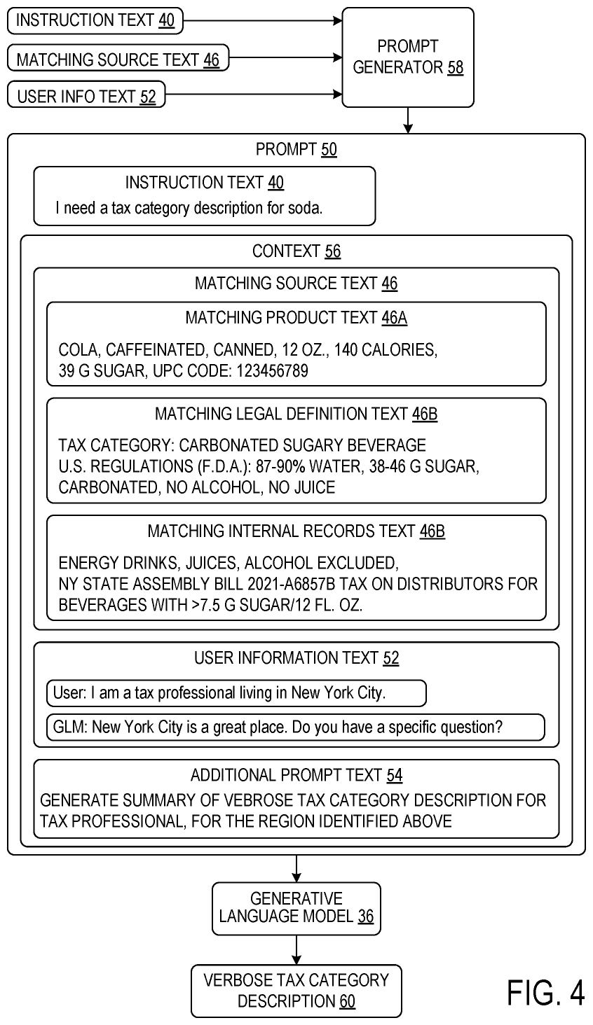

FIG. 4 illustrates an example prompt 50, including the instruction text 40 and context 56, which may include the matching source text data 46, the user information text 52, and additional prompt text 54. As discussed above with reference to FIG. 1, the instruction text 40 and user information text 52 are transmitted to the prompt generator 48 from the prompt interface 34. The matching source text data 46 is identified using its relationship to the matching source text embeddings 44, which were identified by the similarity algorithm 42 in the vector database system 30. Additional prompt text 54 may be, for example, engineered prompt text that has been written to elicit appropriate responses from the generative language model. The additional prompt text may include text that instructs the generative language model to give multi-paragraph answers, with detailed examples, written in formal style, to an expert in the field, or for a particular geographic region, for example. Inclusion of these details helps ensure that the responses from the generative language model 36 adhere to a consistent standard of quality that is desired for the verbose tax category descriptions. Through the use of additional prompt text 54, the prompt generator 48 may be configured to generate the prompt 50 to specify that the verbose tax category description 60 includes elements such as a description of the tax category, decision criteria (i.e., boundaries, exclusionary factors) that determine what products are included in the tax category, jurisdictional differences, and exemplary products, for example.

In the example illustrated in FIG. 4, the instruction text 40 included in the prompt 50 instructs the GLM 36 to generate a verbose tax category description 60 for soda. With reference to FIGS. 2A, 2B, and 2C, the matching source text data 46 included in the prompt 50 may include matching product text 46A extracted from the product information database 24A, matching legal definition text 46B extracted from the legal tax category definitions database 24B, and matching internal records text 46C extracted from the internal research 24C database. Each of these matching texts is determined to be matching the instruction text 40 and user information text 52 using the similarity algorithm 42 discussed above.

Continuing with the example of a verbose tax category description for soda, the matching product text 46A may include a product that is identified as a caffeinated cola beverage that is packaged in a 12 ounce can. Additional information may include nutritional values per serving size, such as a calorie content of 140 calories and a sugar content of 39 grams of sugar, for example. Any standard codes associated with the product, including a universal product code (UPC), may also be extracted from the product information database 24A.

The matching legal definition text 46B may indicate that soda is in the defined tax category entitled “carbonated sugary beverage” and include information related to the definition of soda by the U.S. Food and Drug Administration (FDA), such as the requirements to be 87-90% water, contain 38-46 grams of sugar, have carbonation, and not have measurable amounts of alcohol or juice.

The matching internal records text 46B may include information from interactions with customers, notes/memos from tax professionals, and decision criteria for what is included in the defined tax category. For example, an exchange with a customer who asked if energy drinks, carbonated juice beverages, and carbonated canned cocktails are in the same tax category as soda may be stored as a correspondence record that indicates energy drinks are not included in the defined tax category, and beverages in the defined tax category cannot contain juice or alcohol. A memo from a tax professional my reflect recent changes in jurisdictional rules with regard to the defined tax category, such as noting that the New York State Senate amended the tax law in the 2021-2022 session to impose an excise tax on distributors such that beverages with greater than 7.5 grams but less than 30 grams of sugar per twelve fluid ounces are taxed at the rate of one cent per ounce, and beverages with greater than 30 grams of sugar per twelve fluid ounces are taxed at the rate of two cents per ounce.

As discussed above with reference to FIG. 3, the user information text 52 shows that the user is a tax professional living in New York City, and the GLM 28 displayed a previous response 52B to ask if there was a specific question regarding the previous prompt 52A.

From the information included in the instruction text 40, matching source text data 46, and user information text 52, the additional prompt text 54 may comprise guidelines and boundaries for the generating the verbose tax category description 60, such as displaying the verbose tax category description text 60A as a summary at the skill level of a tax professional, for a tax jurisdiction of a geographic region of the user (i.e., New York City). The verbose tax category description text 60A may be in the form of a dossier. The dossier may include a summary defining the tax category, common sub-categories, and common taxability approaches for the tax category, as well as a glossary of keywords, definitions, and other common terms related to the tax category and taxability definitions.

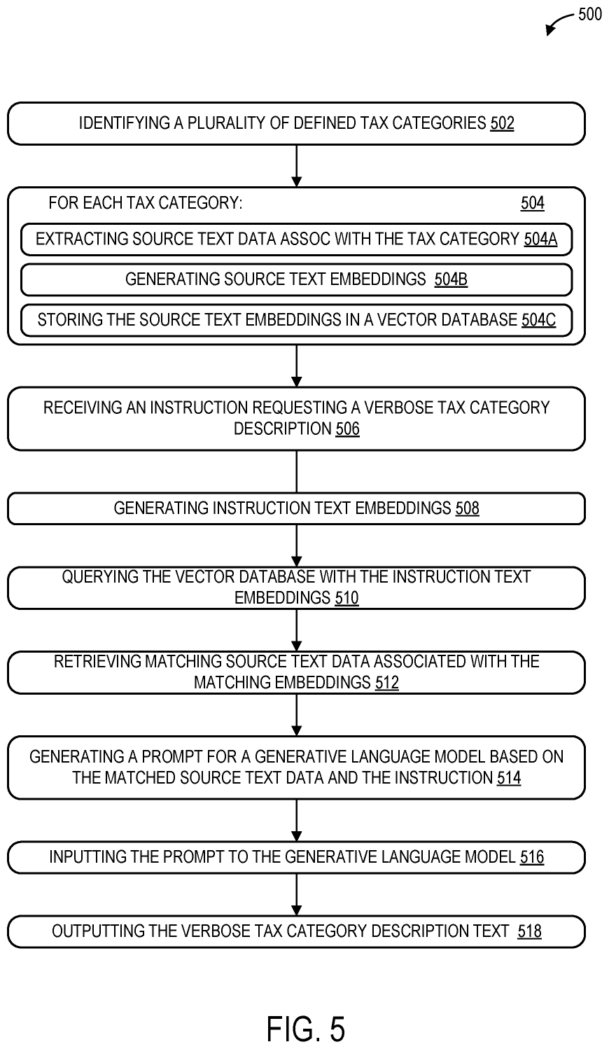

FIG. 5 shows a flowchart for a method 500 for generating a verbose tax category description. The method 500 may be implemented by the computing system 10 illustrated in FIG. 1, or via other suitable hardware and software.

At step 502, the method 500 may include identifying a plurality of defined tax categories. Continuing from step 502 to step 504, for each defined tax category of the plurality of defined tax categories, the method 500 may include extracting text data associated with the defined tax category (504A), generating a plurality of embeddings representing the text data (504B), and storing the plurality of embeddings in a vector database (504C).

As described in detail above, the method 500 may further include storing the text data associated with the defined tax category in a legal definition database and identifying at least one governing body for the defined tax category. The method may further include monitoring the at least one governing body for updates, updating the tax category embeddings representing the text data associated with the defined tax category in the vector database, and revising product mapping according to the updated text data. The text data may include at least one of jurisdictional rules, jurisdictional regulations, industry bodies, and industry standards for defining the tax category.

The method 500 may further include storing the text data associated with the defined tax category in a product database, and the text data may include metadata and attributes for at least one sample product that is mapped to the defined tax category. The metadata and attributes may include at least one of a product description, a physical attribute, a product tree location, nutritional information, and a standard product code.

The method 500 may further include storing the text data associated with the defined tax category in an internal research database, and the text data may include at least one of notes relevant to the defined tax category, correspondence related to the defined tax category, and decision criteria for assigning the defined tax category to one or more products.

Proceeding from step 504 to step 506, the method 500 may include receiving an instruction requesting a verbose tax category description. As described in detail above, the instruction may be input by a user into a prompt interface presented in a GUI. The instruction may indicate a tax category for which the verbose tax category description is requested, such as a tax category name, a tax category type, a product, and/or a jurisdiction, for example.

Advancing from step 506 to step 508, generating instruction text embeddings for the instruction text. The instruction text embeddings may be generated by an embedding model, which may also generate the respective source text embeddings and embeddings representing user information text. The instructions text embeddings and the user information text embeddings may comprise input embeddings.

Continuing from step 508 to step 510, the method 500 may include querying the vector database with the instruction text embeddings to identify a subset of matching embeddings from among the respective source text embeddings stored in the vector database representing the source text data for each defined tax category. The matching source embeddings may be identified via a similarity algorithm that scans the vector database.

Proceeding from step 510 to step 512, the method 500 may include retrieving matching source text data associated with the matching embeddings. The matching source text data is sent to the prompt generator.

Advancing from step 512 to step 514, the method 500 may include generating a prompt for a generative language model based on the matching source text data and the instruction. The prompt may further include user information, such as a user interaction history between a user and the generative language model, user location, user occupation, company type, business domain, and other information that provides context about the user, and additional prompt text identified via the input embeddings representing the instruction text and user information text. The matching source text data, user information text, and the additional prompt text provide context for the instruction text in the prompt.

Continuing from step 514 to step 516, the method 500 may include inputting the prompt to the generative language model to thereby generate verbose tax category description text for the verbose tax category description.

Proceeding from step 516 to step 518, the method 500 may include outputting the verbose tax category description text. The verbose tax category text may be displayed in the prompt interface of the GUI. The verbose tax category description may be stored in a verbose tax category description database.

Using the above described systems and methods, verbose tax category descriptions may be generated, in response to input text from users or from programmatic text inputs from programs such as scripts. In this manner, individual verbose tax categories can be produced, or a catalog of verbose tax category descriptions for a large set of tax categories may be produced. The systems and method described above can achieve both an efficiency in the production of verbose tax category descriptions, and a high quality of the verbose tax category descriptions themselves.

In some embodiments, the methods and processes described herein may be tied to a computing system of one or more computing devices. In particular, such methods and processes may be implemented as a computer-application program or service, an application-programming interface (API), a library, and/or other computer-program products.

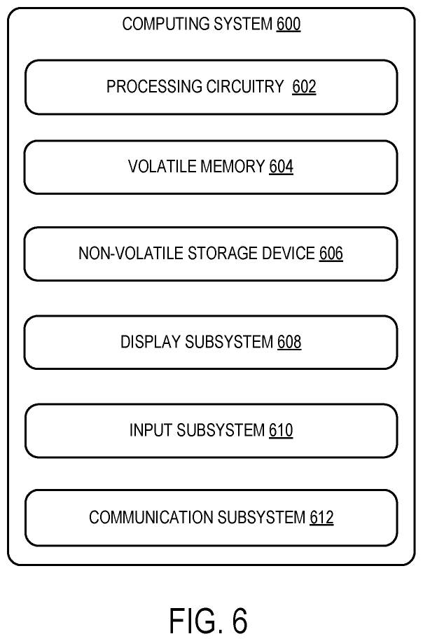

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 6010, communication subsystem 6012, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 6010 may comprise or interface with one or more user-input devices such as a keyboard, mouse, touch screen, camera, or microphone.

When included, communication subsystem 6012 may be configured to communicatively couple various computing devices described herein with each other, and with other devices. Communication subsystem 6012 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a verbose tax category description, the computing system comprising:
a computing device including processing circuitry configured to execute instructions using portions of associated memory to:
identify a plurality of defined tax categories, and, for each defined tax category of the plurality of defined tax categories:
extract source text data associated with the defined tax category from a text source,
generate respective source text embeddings representing the source text data, and
store the respective source text embeddings in a vector database;
receive an instruction requesting a verbose tax category description, the instruction including instruction text indicating a tax category;
generate instruction text embeddings for the instruction text;
query the vector database with the instruction text embeddings to identify a subset of matching embeddings from among the respective source text embeddings stored in the vector database representing the source text data for each defined tax category;
retrieve matching source text data associated with the matching embeddings;
generate a prompt for a generative language model based on the matching source text data and the instruction text;
input the prompt to the generative language model, to thereby generate verbose tax category description text for the verbose tax category description; and
output the verbose tax category description text.

2. The computing system of claim 1, wherein
the source text data associated with the defined tax category is stored in a legal definition database,
at least one governing body for the defined tax category is identified, and
the source text data includes at least one of jurisdictional rules, jurisdictional regulations, industry bodies, and industry standards for defining the tax category.

3. The computing system of claim 1, wherein
the source text data associated with the defined tax category is stored in a product database, and
the source text data includes metadata and attributes for at least one sample product that is mapped to the defined tax category.

4. The computing system of claim 1, wherein
the source text data associated with the defined tax category is stored in an internal research database, and
the source text data includes at least one of notes relevant to the defined tax category, correspondence related to the defined tax category, and decision criteria for assigning the defined tax category to one or more products.

5. The computing system of claim 3, wherein
the metadata and attributes include at least one of a product description, a physical attribute, a product tree location, nutritional information, and a standard product code.

6. The computing system of claim 1, wherein
the instruction text includes at least one of a tax category name, a tax category type, a product, and a jurisdiction.

7. The computing system of claim 1, wherein
the context is selected from the vector database according to deterministic rules.

8. The computing system of claim 1, wherein
the context is selected from the vector database according to evaluation of the verbose tax category description output by the generative language model during prompt engineering.

9. The computing system of claim 1, wherein
user interaction history text between a user and the generative language model is included in the prompt.

10. The computing system of claim 2, wherein the processing circuitry is further configured to:
monitor the at least one governing body for updates,
update the source tax category embeddings representing the source text data associated with the defined tax category in the vector database, and
revise product mapping according to the updated source text data embeddings.

11. A method for generating a verbose tax category description, the method comprising:
identifying a plurality of defined tax categories;
for each defined tax category of the plurality of defined tax categories:
extracting source text data associated with the defined tax category from a text source,
generating respective source text embeddings representing the source text data, and
storing the respective source text embeddings in a vector database;
receiving an instruction requesting a verbose tax category description, the instruction including instruction text indicating a tax category;
generating instruction text embeddings for the instruction text;
querying the vector database with the instruction text embeddings to identify a subset of matching embeddings from among the respective source text embeddings stored in the vector database representing the source text data for each defined tax category;
retrieving matching source text data associated with the matching embeddings;
generating a prompt for a generative language model based on the matching source text data and the instruction;
inputting the prompt to the generative language model to thereby generate verbose tax category description text for the verbose tax category description; and
outputting the verbose tax category description text.

12. The method of claim 11, the method further comprising:
storing the source text data associated with the defined tax category in a legal definition database; and
identifying at least one governing body for the defined tax category, wherein
the source text data includes at least one of jurisdictional rules, jurisdictional regulations, industry bodies, and industry standards for defining the tax category.

13. The method of claim 11, the method further comprising:
storing the source text data associated with the defined tax category in a product database, wherein
the source text data includes metadata and attributes for at least one sample product that is mapped to the defined tax category.

14. The method of claim 11, the method further comprising:
storing the source text data associated with the defined tax category in an internal research database, wherein
the source text data includes at least one of notes relevant to the defined tax category, correspondence related to the defined tax category, and decision criteria for assigning the defined tax category to one or more products.

15. The method of claim 13, wherein
the metadata and attributes include at least one of a product description, a physical attribute, a product tree location, nutritional information, and a standard product code.

16. The method of claim 11, the method further comprising:
selecting the context from the vector database based on deterministic rules.

17. The method of claim 11, the method further comprising:
selecting the context from the vector database based on evaluation of the verbose tax category description output by the generative language model during a training phase.

18. The method of claim 11, the method further comprising:
including user interaction history text between a user and the generative language model in the prompt.

19. The method of claim 12, the method further comprising:
monitoring the at least one governing body for updates,
updating the tax category embeddings representing the text data associated with the defined tax category in the vector database, and
revising product mapping according to the updated text data.

20. A computing system for generating a verbose tax category description, the computing system comprising:
a computing device including processing circuitry configured to execute instructions using portions of associated memory to:
identify a plurality of defined tax categories, and, for each defined tax category of the plurality of defined tax categories:
extract source text data associated with the defined tax category from a text source,
generate respective source text embeddings representing the source text data, and
store the respective source text embeddings in a vector database;
receive an instruction requesting a verbose tax category description, the instruction including instruction text indicating a tax category;
generate instruction text embeddings for the instruction text;
query the vector database with the instruction text embeddings to identify a subset of matching embeddings from among the respective source text embeddings stored in the vector database representing the source text data for each defined tax category;
retrieve matching source text data associated with the matching embeddings;
generate a prompt for a generative language model based on the matching source text data and the instruction;
send the prompt to the generative language model; and
receive a response from the generative language model.
